(19) United States
(12) Patent Application Publication
(10) Pub. No.: US 2024/0419821 A1
(43) Pub. Date: Dec. 19, 2024

(54) AUTHENTICATION METHOD AND APPARATUS, AND ELECTRONIC DEVICE

(71) Applicant: Beijing Zitiao Network Technology Co., Ltd., Beijing (CN)

(72) Inventors: Samuel Cui, Beijing (CN); Yitong Wang, Beijing (CN); Guofeng Zhang, Beijing (CN); Lin Wu, Beijing (CN); Zisheng Liu, Beijing (CN)

(21) Appl. No.: 18/744,478

(22) Filed: Jun. 14, 2024

(30) Foreign Application Priority Data
Jun. 16, 2023 (CN) 202310715571.2

(51) Int. Cl. G06F 21/62; G06F 21/31

(52) U.S. Cl. CPC G06F 21/62; G06F 21/31

(57) ABSTRACT

Disclosed in embodiments of the present disclosure are an authentication method, an authentication apparatus, and an electronic device. A first workflow viewing request is sent to a service system, in a case that the service system returns first workflow data, the first workflow data can be displayed. While returning the first workflow data, the service system also returns first verification information. When a first operation needs to be executed on the first workflow data, whether the first operation is allowed to be executed can be determined by sending the first verification information to the service system. In this way, the service system can determine whether the first operation is allowed to be executed using the first verification information previously fed back to an execution body, and display an execution result of the first operation when the first operation is allowed to be executed.

### CROSS-REFERENCE TO RELATED APPLICATION

The present application claims the priority to Chinese Patent Application No. 202310715571.2, filed on Jun. 16, 2023, and entitled “AUTHENTICATION METHOD AND APPARATUS, AND ELECTRONIC DEVICE”, which is incorporated in its entirety herein by reference.

### FIELD

The present disclosure relates to the technical field of computers, in particular to an authentication method, an authentication apparatus, and an electronic device.

### BACKGROUND

With the development of online office, the content for an enterprise workflow can be conducted online, for example, the content for approval can be approved online. The online approach allows some participants to view workflow documents and thus to process them. However, during processing, users who can view the document may also be added, resulting in poor security.

### SUMMARY

The summary of the present disclosure is provided to introduce concepts in a simplified form, and the concepts are described in detail in the detailed description of the embodiments below. The summary of the present disclosure is neither intended to identify key features or essential features of the claimed solutions, nor intended to limit the scope of the claimed solutions.

Embodiments of the present disclosure provide an authentication method, an authentication apparatus, and an electronic device. In an authentication process of a service system, when a user needs to operate a workflow, a verification may be performed based on verification information returned from the service system, such that security when the service system processes the workflow can be guaranteed, and the first authentication (authentication for viewing workflow data) can be associated with the second authentication. Specifically, the second authentication may be performed on the basis of the first authentication. In this way, not only security of the authentication process is guaranteed, but also a development cost required for setting two times of authentication is reduced.

In a first aspect, embodiments of the present disclosure provide an authentication method. The method includes: sending a first workflow viewing request to a service system, where the service system is configured to return first workflow data and first verification information based on an identity of a sender satisfying a permission requirement; displaying the returned first workflow data; generating a first operation request in response to detecting a first operation on the displayed first workflow data, and sending the first operation request to the service system, where the first operation request includes the first verification information, and the service system determines whether the first operation is allowed to be executed based on the first verification information; and displaying an execution result of the first operation in response to the first operation being allowed to be executed.

In a second aspect, embodiments of the present disclosure provide an authentication apparatus. The apparatus includes: a sending unit, configured to send a first workflow viewing request to a service system, where the service system is configured to return first workflow data and first verification information based on an identity of a sender satisfying a permission requirement; a first display unit, configured to display the returned first workflow data; a generation unit, configured to generate a first operation request in response to detecting a first operation on the displayed first workflow data, and send the first operation request to the service system, where the first operation request includes the first verification information, and the service system determines whether the first operation is allowed to be executed based on the first verification information; and a second display unit, configured to display an execution result of the first operation in response to the first operation being allowed to be executed.

In a third aspect, embodiments of the present disclosure provide an electronic device. The electronic device includes: one or more processors; and a memory for storing one or more programs, where the one or more programs, when executed by the one or more processors, cause the one or more processors to implement the authentication method according to the first aspect.

In a fourth aspect, embodiments of the present disclosure provide a computer-readable medium, storing a computer program. The program, when executed by a processor, implements steps of the authentication method according to the first aspect.

According to the authentication method, the authentication apparatus, and the electronic device provided in embodiments of the present disclosure, the first workflow viewing request is sent to the service system, and the service system can return the first workflow data and the first verification information based on the identity of the sender satisfying the permission requirement. When the first operation needs to be executed on the first workflow data, it can be determined whether to execute the first operation on the first workflow data by sending the first verification information to the service system. In this way, the service system may determine whether the first operation is allowed to be executed on the first workflow data using the first verification information previously fed back to the execution body. The execution result of the first operation may be displayed if the first operation is allowed to be executed. Therefore, in the present disclosure, the authentication verification is performed using the first verification information fed back previously, such that it can be avoided that the execution body needs to generate verification information for many times in an authentication process. Not only efficiency of authentication verification can be improved, but also the authentication verification process may be safer since a verification flow is simplified.

### BRIEF DESCRIPTION OF THE DRAWINGS

The above and other features, advantages, and aspects of embodiments of the present disclosure will become more apparent with reference to the following particular embodiments in conjunction with the drawings. The same or similar reference numerals refer to the same or similar elements throughout the drawings. It should be understood that the drawings are schematic, and that the parts and elements are not necessarily drawn to scale.

FIG. 1 is a flowchart of an embodiment of an authentication method according to the present disclosure;

FIG. 2 is a schematic diagram of an interaction process of an embodiment of an authentication method according to the present disclosure;

FIGS. 3A-3B are schematic diagrams of first workflow data of an embodiment of an authentication method according to the present disclosure;

FIG. 4 is a schematic structural diagram of an embodiment of an authentication apparatus according to the present disclosure;

FIG. 5 shows an illustrative system architecture to which an authentication method according to an embodiment of the present disclosure can be applied; and

FIG. 6 is a schematic diagram of a basic structure of an electronic device according to embodiments of the present disclosure.

### DETAILED DESCRIPTION OF EMBODIMENTS

Embodiments of the present disclosure are described in more detail below with reference to the drawings. Although some embodiments of the present disclosure are authenticated in the drawings, it should be understood that the present disclosure may be embodied in various forms and should not be construed as being limited to embodiments set forth herein. On the contrary, these embodiments are provided, such that the present disclosure will be understood more thoroughly and completely. It should be understood that the drawings and embodiments of the present disclosure are for illustrative purposes merely and are not intended to limit the scope of protection of the present disclosure.

It should be understood that various steps recited in the method embodiments of the disclosure can be executed in different orders and/or in parallel. Furthermore, the method embodiments can include additional steps and/or omit to execute the illustrated steps. The scope of the present disclosure is not limited in this respect.

As used herein, the term “comprise” or “include” and their variations are open-ended, that is, “comprise but not limited to” and “include but not limited to”. The term “based on” is “based at least in part on”. The term “an embodiment” means “at least one embodiment”. The term “another embodiment” means “at least one further embodiment”. The term “some embodiments” means “at least some embodiments”. Definitions for other terms are given in the description below.

It should be noted that concepts such as “first” and “second” mentioned in the present disclosure are merely used to distinguish different apparatuses, modules or units, and are not used to limit the order of functions executed by these apparatuses, modules or units or their interdependence.

It should be noted that the modification with “a/an”, or “a plurality of/multiple” in the present disclosure is intended to be illustrative rather than limitative, and should be understood by those skilled in the art as “one or more” unless the context clearly dictates otherwise.

The names of messages or information exchanged between a plurality of apparatuses in the embodiments of the present disclosure are merely for illustrative purposes, and are not intended to limit the scope of these messages or information.

Before introducing an inventive concept of the present disclosure, an application scene of the present application is briefly described to better understand the application scene of the present application. The present application may be applied to workflow processing, in which the authentication of a user identity is required. For example, in order to guarantee security of a workflow, not every user can operate on the workflow, but only some users can operate on the workflow, in which case authentication may be required.

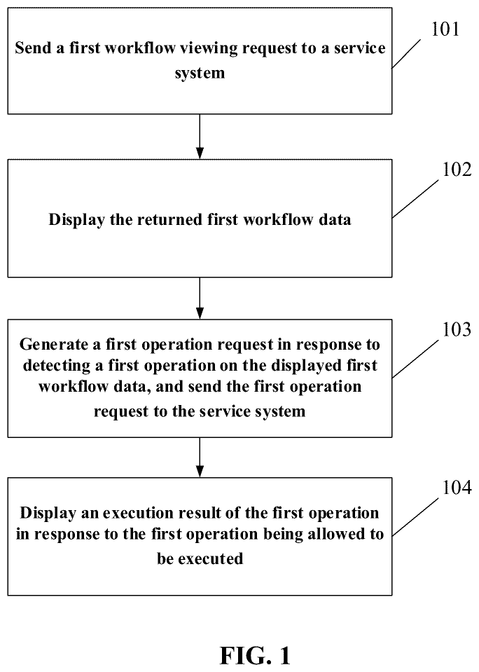

With reference to FIG. 1, a flow of an embodiment of an authentication method according to the present disclosure is shown. As shown in FIG. 1, the authentication method includes: steps 101-104.

S101. A first workflow viewing request is sent to a service system.

Herein, the service system is configured to return first workflow data and first verification information if an identity of a sender satisfies a permission requirement.

As an instance, the first workflow may be interpreted as a workflow that a current user (the user who sends the first workflow viewing request, or a sender) wants to view. In different scenes, the workflow that the user needs to view may be different. For example, the workflow may include, but is not limited to, a financial information workflow, a personnel information workflow, a recruitment planning workflow, etc. Correspondingly, the workflow data may include, but is not limited to, a financial statement, a personnel information report, a recruitment plan report, etc.

It should be understood that the workflow data may require certain confidentiality, and therefore, in order to avoid that all users can view the workflow data, it is necessary to authenticate the identity of the sender, so as to avoid leakage of the workflow data.

Certainly, authentication of identity permission of the sender may be reasonably set according to an actual situation, which is not limited herein. For example, an identity table may be set to determine whether the identity of the sender is included in the identity table, such that whether the identity of the sender satisfies a permission requirement can be determined.

As an instance, the service system can query the workflow data and return the workflow data to an execution body. It should be understood that the execution body may be understood as a terminal where the user triggers the first workflow viewing request.

As an instance, the first verification information may be understood as verification information for the user to perform a further operation on the first workflow subsequently. What content may be included in the first verification information may be defined according to an actual situation. Only, when the identity of the sender satisfies a permission requirement, the service system sends the first verification information and the first workflow data to the execution body together.

Step 102. The returned first workflow data is displayed.

As an instance, after the execution body displays the returned first workflow data, the user can view the first workflow data. In this case, the user may perform a further operation on the first workflow data, such as downloading, sharing, etc.

Step 103. A first operation request is generated in response to detecting a first operation on the displayed first workflow data, and the first operation request is sent to the service system.

The first operation request includes the first verification information, and the service system determines, based on the first verification information, whether the first operation is allowed to be executed on the first workflow data.

It should be understood that the first operation herein includes, but is not limited to, downloading and sharing operations on the first workflow data.

As an instance, since the first verification information is returned to the execution body by the service system, when the first operation needs to be executed on the first workflow data, the execution body may send the first verification information back to the service system to enable the service system to determine whether the first operation is allowed to be executed. That is, the service system directly uses the first verification information fed back previously, to verify whether to perform the first operation, such that a verification cost can be reduced.

For ease of understanding, an instance may be provided. In an authentication process of the service system, different verification information may represent different permission. Therefore, when feeding back the first verification information to the execution body, the service system may have learned the permission corresponding to the first verification information, such that when the execution body sends the first verification information to the service system again, the service system can conveniently determine whether to allow the first operation to be executed on the first workflow data currently. In this way, it is avoided that the execution body needs to generate verification information for many times in the authentication process, such that the authentication efficiency can be improved, and the accuracy of the authentication process can also be improved.

Step 104. An execution result of the first operation is displayed in response to the first operation being allowed to be executed.

As an instance, in response to allowing the first operation, it may be characterized that the verification passes. In this case, the first operation can be executed on the first workflow data, and an execution result after executing the first operation on the first workflow flow data can be directly displayed. For example, the first operation is a downloading operation, and information for prompting a storage location of the downloaded first workflow data for a user may be directly displayed (in this case, the execution result may be understood as: downloading is allowed, and the user is allowed to select the storage location for the downloaded content).

In the related art, when the service system needs to perform a plurality of times of authentication, the execution body generates authentication information for a plurality of times, such that more processing flows need to be performed in the authentication process, which not only increases the development cost in the plurality of times of authentication process, but also makes the authentication process insecure.

In the present disclosure, the first workflow viewing request is sent to the service system, and the service system can return the first workflow data and the first verification information if the identity of the sender satisfies the permission requirement. When the first operation needs to be executed on the first workflow data, it can be determined whether to execute the first operation on the first workflow data by sending the first verification information to the service system. In this way, the service system may determine whether the first operation is allowed to be executed on the first operation flow data by using the first verification information previously fed back to the execution body. Then the execution result of the first operation may be displayed when the first operation is allowed to be executed. It can be seen that in the present disclosure, the authentication verification is performed using the first verification information fed back previously, such that it can be avoided that the execution body needs to generate verification information for many times in an authentication process. Not only efficiency of authentication verification can be improved, but also the authentication verification process may be safer since a verification flow is simplified.

In some implementations, the first operation includes at least one of the following: sharing the first workflow data to a designated platform, commenting on the first workflow data, accessing or saving an attachment in the first workflow, etc.

The designated platform herein may be an application, a system, a client, a server, etc.

In some implementations, the first verification information includes identity identification information, and/or attachment identification information corresponding to the first workflow data.

Herein, the attachment identification information is used to indicate a duration for obtaining the first workflow data.

As an instance, the identity identification information may indicate an identity of the current user, and the service system may determine whether the first operation can be executed based on the identity of the user.

The attachment identification information is used to indicate the duration for obtaining the first workflow data. Generally speaking, the longer the duration for obtaining the first workflow data is, the higher a risk of the first workflow data being leaked is. Therefore, whether the first operation can be executed on the first workflow data may be determined based on the duration for obtaining the first workflow data, and in addition the security of the first workflow data may be determined.

In some implementations, the first verification information includes the identity identification information. The service system determines whether the first operation is allowed to be executed based on the first verification information specifically by: determining that the first operation is allowed to be executed based on determining that a predefined account includes a user account indicated by the identity identification information.

As an instance, the predefined account may be understood as an account that may execute the first operation on the first workflow data. For example, user accounts corresponding to certain higher-ranking users may be determined as predefined accounts, such that the first operation may be executed on the first workflow data by using such accounts.

In a possible implementation, the identity identification information may be generated by a server of the execution body. After the server of the execution body generates the identity identification information, the identity identification information may be sent to the service system. After the service system verifies that the identity identification information satisfies the requirement, the service system may return the first workflow data to the execution body. In addition, a front-end of the execution body may display the first workflow data and returns the first verification information. Correspondingly, in a case that the verification fails, prompt information indicating that the verification fails may be returned to the execution body.

Further, when detecting the first operation on the displayed first workflow data, the execution body may send the first operation request to the service system, such that the service system may determine whether to allow the first operation to be executed on the first workflow data based on the first verification information (may be identity identification information and/or attachment identification information). In this way, when the second authentication is required, the first verification information can be used for verification, and no authentication information needs to be generated again. That is, the second authentication can be performed on the basis of the first authentication, not only authentication is more efficient, but also a development cost is reduced.

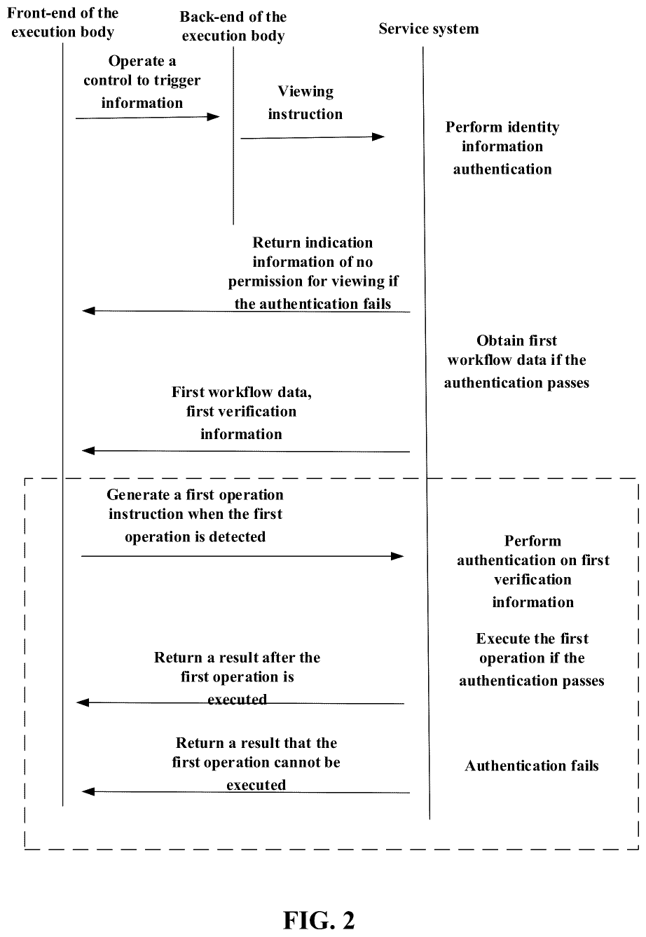

For ease of understanding, description can be made with reference to FIG. 2, which is a schematic diagram of interaction between the execution body and the service system. As can be seen from FIG. 2, after the front-end of the execution body obtains the user operation, the first workflow viewing request can be generated at a back-end of the execution body. Then the service system can perform verification, obtains the first workflow data, and returns the first workflow data to the front-end of the execution body for display, where the first verification information is also returned in this process. In a case that the user still needs to perform the first operation on the first workflow data, the first operation request including the first verification information may be sent to the service system, such that the service system may perform permission verification. Therefore, in this way, the second authentication process (authentication process in a dotted line block) can be performed on the basis of the first authentication, such that the development cost in a plurality of authentication processes can be reduced.

In some implementations, the first verification information may include the attachment identification information corresponding to the first workflow data. The service system determines whether the first operation is allowed to be executed based on the first verification information specifically by: determining that the first operation is allowed to be executed based on determining that the duration indicated by the attachment identification information is less than a preset duration.

It should be understood that on the one hand, after the first workflow data is generated, the risk of the first workflow data being leaked gradually increases over time. Therefore, by determining whether the first operation can be executed on the first workflow data based on the duration indicated by the attachment identification information, the leakage of the first workflow data can be avoided. For example, the first workflow data is prevented from being seriously leaked by avoiding sharing and downloading the first workflow data by users at any time. On the other hand, the first workflow data may also be updated over time (for example, the first workflow data is a financial statement, and the financial statement may have been updated over time). The first workflow data obtained by the user may also be accurate data through determination by time.

In some implementations, the first verification information includes identity identification information and attachment identification information corresponding to the first workflow data. The service system determines whether the first operation is allowed to be executed based on the first verification information specifically by: determining that the first operation is allowed to be executed, based on determining that a predefined account includes a user account indicated by the identity identification information and that the duration indicated by the attachment identification information is less than a preset duration.

That is, only the predefined account can execute the first operation on the first workflow data within the preset duration, such that leakage of the first workflow data can be avoided, and the security of the first workflow data can be guaranteed.

In some implementations, the predefined account includes at least one of the following types of accounts: a preset account; or an account with preset permission opened by using the preset account.

As an instance, the preset account may be understood as an account with higher permission, for example, an account corresponding to a chief financial officer, an account corresponding to a general manager, an account corresponding to a president, etc. Such accounts usually have higher permission, and they can be identified as preset accounts.

Since the preset account has higher permission, the preset account may generally specify that certain accounts can operate on the first workflow data. For example, the preset account may be used to instruct that an account A can also operate on the first workflow data, such that the account A can operate on the first workflow.

For example, the first workflow data is forwarded to a certain account by using the preset account, such that the account receiving the first workflow data has preset permission of the first workflow data. For another example, comments are made on the first workflow data in a process of browsing the first workflow data by using the preset account, and a certain account is mentioned in the process of commenting, such that the account may also have preset permission on the first workflow data.

It should be understood that which permission may be specifically included in the preset permission may be limited according to an actual situation. For example, the preset permission may include one or more of: viewing permission, forwarding permission, commenting permission, etc.

In some implementations, the viewing request includes identity identification information. The identity identification information corresponds to a viewing level. Different viewing levels are corresponding to different first workflow data. The service system obtains the first workflow data based on the identity identification information.

As an instance, the first workflow data may include a plurality of subdata, and security levels corresponding to different subdata may be different. For example, the first workflow data includes data indicating identity information, and the subdata may include: subdata indicating basic identity information, subdata indicating a specific address, subdata indicating a spouse and emergency contact, etc. The security levels corresponding to the subdata may be different, for example, security levels of the subdata corresponding to a specific address, spouse and emergency contact information, etc. may be higher. For another example, the first workflow data is used to indicate a financial statement, and the subdata may include: expenditure subdata, income subdata, expenditure and income detail subdata, etc. The security levels of the subdata are also different. For example, the security level of the expenditure and income detail subdata may be higher.

Moreover, different users correspond to different ranks, and users of different ranks have different permission. Correspondingly, different identity identification information may correspond to different viewing levels, and different viewing levels may also view different contents.

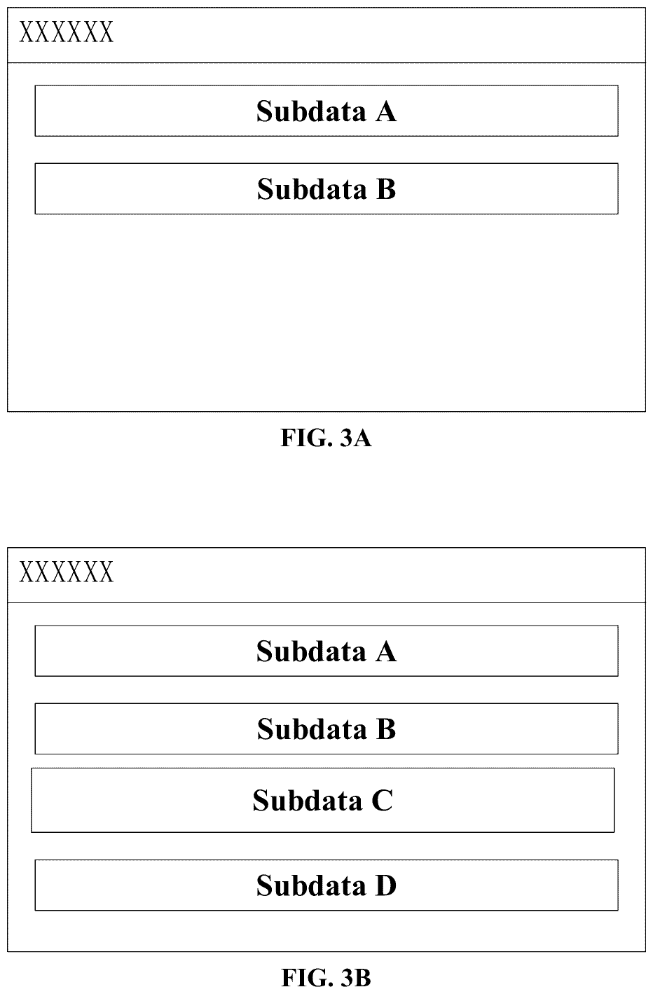

For ease of understanding, description may be made with reference to FIGS. 3A and 3B. FIG. 3A is a schematic diagram of first workflow data obtained by using identity identification information of a user A. FIG. 3B is a schematic diagram of first workflow data obtained by using identity identification information of a user B. A rank of the user A is lower than a rank of the user B. It can be seen from FIGS. 3A-3B that when the ranks of users are different, contents in the first workflow data that can be obtained are different, that is, the rank of the user A cannot view subdata C and subdata D.

In some implementations, the viewing level may correspond to the security level of the subdata, such that the first workflow data may be conveniently determined based on the identity identification information.

In some implementations, the viewing level corresponds to a rank of a user account indicated by the identity identification information.

As an instance, the higher the rank is, the higher the corresponding viewing level is, which can also indicate that the user account can view more contents.

It can be seen that when the first workflow data is obtained and displayed, displayed contents corresponding to different users may be inconsistent, a user with a higher rank may view more contents, while a user with a lower rank may only view less contents.

In some implementations, in response to determining that a first user account sends the first workflow data to a second user account, whether a rank of the first user account is greater than a rank of the second user account is determined. At least one type of permission configuration information is displayed if the rank of the first user account is greater than the rank of the second user account. In addition, a viewing level of the second user account is determined based on selected permission configuration information.

Herein, the permission configuration information is used to indicate viewing permission.

As an instance, applicability of the present disclosure may be made higher by displaying the permission configuration information when the first user account sends the first workflow data to the second user account.

For example, when the first user would like the second user to view the first workflow data A, the second user cannot view the first workflow data A completely (for example, only a part of the first workflow data A can be viewed) since the rank of the second user may not be high enough. Therefore, when the first user sends the first workflow data A to the second user, the viewing level may be configured directly for the second user, such that it is convenient for the second user to view the first workflow data A completely.

Correspondingly, it should also be understood that when the user A with a lower rank sends the first workflow data to the user B with a higher rank, the user B may view more contents than the user A while viewing the first workflow data.

In some implementations, the authentication method in the present disclosure may be applied to a scene of approval custody. In the scene of approval custody, the service system may provide a content document to be approved to the execution body, and the execution body may process and convert a content based on the received content document, and may display and approve various approval contents after converting them into a same style at the front-end of the execution body.

In an approval process, different contents of a document may be displayed to users with different permission, that is to say, not all users can view all document contents, but only some users can view the content document. Therefore, in the approval process, users who view the content document need to be authenticated.

For example, in the approval process, a preset user may also send the approval content to other users, e.g., send a certain content document about expenditure to some users for confirmation, and ask some users to confirm identity information, etc., in this case, these users at this time also became predefined accounts.

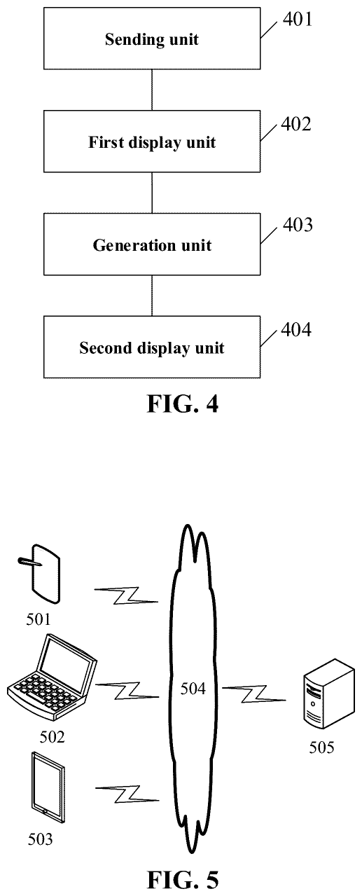

With further reference to FIG. 4, as an implementation of the methods shown in the above figures, the present disclosure provides an embodiment of an authentication apparatus. The apparatus embodiment corresponds to the method embodiment shown in FIG. 1, and the apparatus may be specifically applied to various electronic devices.

As shown in FIG. 4, the authentication apparatus in the embodiments is applied to an electronic device. The electronic device supports screen rotation. The authentication apparatus includes: a sending unit 401, configured to send a first workflow viewing request to a service system, where the service system is configured to return first workflow data and first verification information based on an identity of a sender satisfying a permission requirement; a first display unit 402, configured to display the returned first workflow data; a generation unit 403, configured to generate a first operation request in response to detecting a first operation on the displayed first workflow data, and send the first operation request to the service system, where the first operation request includes the first verification information, and the service system determines whether the first operation is allowed to be executed based on the first verification information; and a second display unit 404, configured to display an execution result of the first operation in response to the first operation being allowed to be executed.

In this embodiment, specific processing of the sending unit 401, the first display unit 402, the generation unit 403, and the second display unit 404 of the authentication apparatus and generated technical effects may be respectively refer to those described with reference to relevant explanation of steps 101-104 in embodiments of FIG. 1, which will not be repeated herein.

In some embodiments, the first verification information includes identity identification information and/or attachment identification information corresponding to the first workflow data. The attachment identification information is used to indicate a duration for obtaining the first workflow data.

In some embodiments, the first verification information includes the identity identification information. The service system determines whether the first operation is allowed to be executed based on the first verification information by: determining that the first operation is allowed to be executed in response to determining that a predefined account includes a user account indicated by the identity identification information.

In some embodiments, the first verification information includes the attachment identification information corresponding to the first workflow data. The service system determines whether the first operation is allowed to be executed based on the first verification information by: determining that the first operation is allowed to be executed in response to determining that the duration indicated by the attachment identification information is less than a preset duration.

In some embodiments, the first verification information includes the identity identification information and the attachment identification information corresponding to the first workflow data. The service system determines whether the first operation is allowed to be executed based on the first verification information by: determining that the first operation is allowed to be executed in response to determining that a predefined account includes a user account indicated by the identity identification information, and that the duration indicated by the attachment identification information is less than a preset duration.

In some embodiments, the predefined account includes at least one of the following types of accounts: a preset account; or an account with preset permission opened by using the preset account.

In some embodiments, the viewing request includes identity identification information. The identity identification information corresponds to a viewing level, and different viewing levels are corresponding to different first workflow data. The service system obtains the first workflow data based on the identity identification information.

In some embodiments, the viewing level corresponds to a rank of a user account indicated by the identity identification information.

In some embodiments, the authentication apparatus is specifically configured to: in response to detecting that a first user account sends the first workflow data to a second user account, determine whether a rank of the first user account is greater than a rank of the second user account; in accordance with a determination that the rank of the first user account is greater than the rank of the second user account, display at least one type of permission configuration information, where the permission configuration information is used to indicate viewing permission; and determine a viewing level of the second user account based on selected permission configuration information.

In some embodiments, the first operation includes at least one of the following: sharing the first workflow data to a designated platform, commenting on the first workflow data, or accessing or saving an attachment in the first workflow.

With reference to FIG. 5, which is an illustrative system architecture in which an authentication method of embodiments of the present disclosure may be used.

As shown in FIG. 5, the system architecture may include terminal devices 501, 502, and 503, a network 504, and a server 505. The network 504 is configured to provide a medium for communication links between the terminal devices 501, 502, 503 and the server 505. The network 504 may include various connection types, such as wired communication links, wireless communication links, fiber optic cables, etc.

The terminal devices 501, 502, 503 may interact with the server 505 by means of the network 504, to receive or send messages, etc. Various client applications, such as web browser applications, search applications, and news applications, may be installed on the terminal devices 501, 502, and 503. The client applications in the terminal devices 501, 502, and 503 may receive instructions from a user and perform corresponding functions according to the instructions from the user, e.g., adding corresponding information to information according to the instructions from the user.

The terminal devices 501, 502 and 503 may be hardware or software. When the terminal devices 501, 502 and 503 are hardware, the terminal devices may be various electronic devices having an authentication screen and supporting web browsing, and include, but not limited to, a smart phone, a tablet computer, an e-book reader, a moving picture experts group audio layer III (MP3) player, a moving picture experts group audio layer IV (MP4) player, a laptop computer, a desktop computer, etc. When the terminal devices 501, 502, and 503 are software, the terminal devices may be installed in the electronic devices listed above. The terminal devices may be implemented as a plurality of pieces of software or software modules (for example, software or software modules configured to provide distributed services) or as a single piece of software or software module, which are not specifically limited herein.

The server 505 may be a server providing various services, e.g., receiving information obtaining requests sent from the terminal devices 501, 502, and 503, obtaining display information corresponding to the information obtaining requests in various ways based on the information obtaining requests, and sending related data of the display information to the terminal devices 501, 502 and 503.

It should be noted that the authentication method provided in embodiments of the present disclosure may be performed by a terminal device. Accordingly, the authentication apparatus may be arranged in the terminal devices 501, 502, and 503. Moreover, the authentication method provided in embodiments of the present disclosure may also be performed by the server 505. Accordingly, the authentication apparatus may be arranged in the server 505.

It should be understood that the number of terminal devices, networks and servers in FIG. 5 is merely illustrative. There may be any number of terminal devices, networks and servers depending on implementation needs.

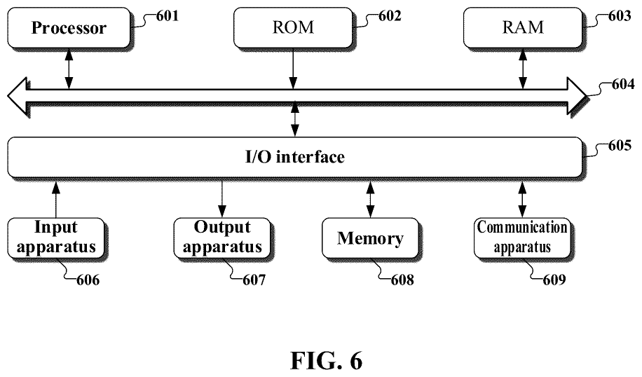

With reference to FIG. 6 below, which illustrates a schematic structural diagram of an electronic device (for example, a terminal device or a server in FIG. 5) suitable for implementing embodiments of the present disclosure. The terminal device in embodiments of the present disclosure may include, but is not limited to, mobile terminals such as a mobile phone, a notebook computer, a digital broadcast receiver, a personal digital assistant (PDA), a portable android device (PAD), a portable multimedia player (PMP), an in-vehicle terminal (for example, an in-vehicle navigation terminal), etc., and fixed terminals such as a digital television (TV), a desktop computer, etc. The electronic device illustrated in FIG. 6 is merely an instance and should not impose any limitation on the functions and scope of use of embodiments of the present disclosure.

As shown in FIG. 6, the electronic device may include a processing apparatus (for example, a central processing unit, a graphics processing unit, etc.) 601 that may execute various appropriate actions and processes according to programs stored in a read-only memory (ROM) 602 or programs loaded from a storage apparatus 608 into a random-access memory (RAM) 603. The RAM 603 also stores various programs and data needed for the operations of the electronic device 600. The processor 601, the ROM 602, and the RAM 603 are connected to each other by means of a bus 604. An input/output (I/O) interface 605 is also connected to the bus 604.

Typically, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, an authentication liquid crystal display (LCD), a speaker, a vibrator, etc.; a storage apparatus 608 including, for example, a magnetic tape, a hard disk, etc.; and a communication apparatus 609. The communication apparatus 609 may allow the electronic device to be in wireless or wired communication with other devices to exchange data. While FIG. 6 illustrates an electronic device having various apparatuses, it should be understood that not all of the illustrated apparatuses are required to be implemented or provided. More or fewer apparatuses may alternatively be implemented or provided.

In particular, according to embodiments of the present disclosure, a processes described above with reference to the flowcharts may be implemented as a computer software program. For example, embodiments of the present disclosure include a computer program product. The computer program product includes a computer program carried on a non-transitory computer-readable medium, and the computer program includes a program code for executing the method illustrated in the flowchart. In such embodiments, the computer program may be downloaded and installed from a network by means of the communication apparatuses 609, or installed from the storage device 608, or installed from the ROM 602. When executed by the processor 601, the computer program executes the above-described functions defined in the method of embodiments of the present disclosure.

It should be noted that the computer-readable medium in the present disclosure may be a computer-readable signal medium or a computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that includes or stores a program for use by or in conjunction with an instruction execution system, apparatus, or device. In the present disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can send, propagate, or transfer a program for use by or in conjunction with an instruction execution system, apparatus, or device. A program code included on a computer-readable medium may be transferred by means of any suitable medium, including, but not limited to, wires, fiber optic cables, radio frequency (RF), etc., or any suitable combination of the foregoing.

In some embodiments, a client side and a server may communicate by using any currently known or future developed network protocol, such as a hypertext transfer protocol (HTTP), and may be interconnected with any form or medium of digital data communication (for example, a communication network). Instances of communication networks include a local area network (LAN), a wide area network (WAN), Internet work (for example, the Internet), and an end-to-end network (for example, an ad hoc end-to-end network), as well as any currently known or future developed network.

The computer-readable medium may be included in the above electronic device, and may also exist independently without being assembled into the electronic device.

The computer-readable medium carries one or more programs. When executed by the electronic device, the one or more programs cause the electronic device to: send a first workflow viewing request to a service system, where the service system is configured to return first workflow data and first verification information based on an identity of a sender satisfying a permission requirement; display the returned first workflow data; generate a first operation request in response to detecting a first operation on the displayed first workflow data, and send the first operation request to the service system, where the first operation request includes the first verification information, and the service system determines whether the first operation is allowed to be executed based on the first verification information; and display an execution result of the first operation in response to the first operation is allowed to be executed.

A computer program code for performing operations of the present disclosure may be written in one or more programming languages, or combinations of the programming languages. The programming languages include, but are not limited to, object-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various embodiments of the present disclosure. In this regard, each block in the flowcharts or block diagrams may represent a module, a program segment, or part of a code, and a module, a program segment, or part of a code includes one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in embodiments of the present disclosure may be implemented in software or hardware. The name of a unit does not constitute a limitation on the unit itself under certain circumstances. For example, a sending unit may also be described as “a unit for sending a first workflow viewing request”.

The functions described above herein may be executed at least partially by one or more hardware logic components, for example, exemplary types of the hardware logic components that may be used include: a field programmable gate array (FPGA), an application specific integrated circuit (ASIC), an application specific standard product (ASSP), a system on chip (SOC), a complex programmable logic device (CPLD), etc. in a non-restrictive way.

In the context of the present disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific instance of the machine-readable storage medium may include an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above description is merely illustrative of preferred embodiments of the present disclosure and principles of the technology employed. It should be understood by those skilled in the art that the disclosed scope involved in the present disclosure is not limited to the technical solutions in which the above-described technical features are specifically combined, but encompasses other technical solutions in which the above-described technical features or equivalent features thereof are arbitrarily combined without departing from the concept of the present disclosure, for example, technical solutions formed by interchanging the features described above with (non-limitative) technical features disclosed in the present disclosure that have similar functions.

Furthermore, although operations are depicted in a particular order, this should not be understood as requiring that such operations be executed in the particular order shown or in a sequential order. In certain circumstances, multitasking and parallel processing may be advantageous. Similarly, although several specific implementation details are included in the above discussion, these details should not be construed as limitations on the scope of the present disclosure. Some features that are described in the context of separate embodiments may also be implemented in combination in a single embodiment. Conversely, various features described in the context of a single embodiment can also be implemented in multiple embodiments separately or in any suitable sub-combination manner.

Although the subject matter has been described in language specific to structural features and/or methodological logical actions, it should be understood that the subject matter defined in the appended claims is not necessarily limited to the specific features or actions described above. On the contrary, the specific features and actions described above are merely instance forms of implementing the claims.

I/We claim:

1. An authentication method, comprising:
sending a first workflow viewing request to a service system, wherein the service system is configured to return first workflow data and first verification information based on an identity of a sender satisfying a permission requirement;
displaying the first workflow data returned from the service system;
sending, to the service system, a first operation request in response to detecting a first operation on the displayed first workflow data, wherein the first operation request comprises the first verification information, and the first operation request is used for the service system to determine whether the first operation is allowed to be executed based on the first verification information; and
displaying an execution result of the first operation in response to the first operation being allowed to be executed.

2. The method of claim 1, wherein the first verification information comprises at least one of:
identity identification information, or
attachment identification information corresponding to the first workflow data, wherein the attachment identification information is used to indicate a duration for obtaining the first workflow data.

3. The method of claim 1, wherein the first verification information comprises identity identification information, and
wherein the service system determines that the first operation is allowed to be executed in response to determining that a predefined account comprises a user account indicated by the identity identification information.

4. The method of claim 2, wherein the first verification information comprises the attachment identification information corresponding to the first workflow data, and
wherein the service system determines that the first operation is allowed to be executed in response to determining that the duration indicated by the attachment identification information is less than a preset duration.

5. The method of claim 2, wherein the first verification information comprises the identity identification information and the attachment identification information corresponding to the first workflow data, and
wherein the service system determines that the first operation is allowed to be executed in response to determining that a predefined account comprises a user account indicated by the identity identification information, and that the duration indicated by the attachment identification information is less than a preset duration.

6. The method of claim 3, wherein the predefined account comprises at least one of the following types of account:
a preset account; and
an account with preset permission opened by using the preset account.

7. The method of claim 1, wherein the viewing request comprises identity identification information, the identity identification information corresponds to a viewing level, and different viewing levels correspond to different first workflow data; and
the service system obtains the first workflow data based on the identity identification information.

8. The method of claim 7, wherein the viewing level corresponds to a rank of a user account indicated by the identity identification information.

9. The method of claim 7, further comprising:
in response to detecting that a first user account sends the first workflow data to a second user account, determining whether a rank of the first user account is greater than a rank of the second user account;
in accordance with a determination that the rank of the first user account is greater than the rank of the second user account, displaying at least one type of permission configuration information, wherein the permission configuration information is used to indicate viewing permission; and
determining a viewing level of the second user account based on selected permission configuration information.

10. The method of claim 1, wherein the first operation comprises at least one of the following: sharing the first workflow data to a designated platform, commenting on the first workflow data, or accessing or saving an attachment in the first workflow.

11. An electronic device, comprising:
one or more processors; and
a memory configured to store one or more programs; wherein
the one or more programs, when executed by the one or more processors, cause the one or more processors to perform actions comprising:
sending a first workflow viewing request to a service system, wherein the service system is configured to return first workflow data and first verification information based on an identity of a sender satisfying a permission requirement;
displaying the first workflow data returned from the service system;
sending, to the service system, a first operation request in response to detecting a first operation on the displayed first workflow data, wherein the first operation request comprises the first verification information, and the first operation request is used for the service system to determine whether the first operation is allowed to be executed based on the first verification information; and
displaying an execution result of the first operation in response to the first operation being allowed to be executed.

12. The electronic device of claim 11, wherein the first verification information comprises at least one of:
identity identification information, or
attachment identification information corresponding to the first workflow data, wherein the attachment identification information is used to indicate a duration for obtaining the first workflow data.

13. The electronic device of claim 11, wherein the first verification information comprises identity identification information, and wherein the first operation request is used for the service system to determine whether the first operation is allowed to be executed based on the first verification information by:
determining that the first operation is allowed to be executed in response to determining that a predefined account comprises a user account indicated by the identity identification information.

14. The electronic device of claim 12, wherein the first verification information comprises the attachment identification information corresponding to the first workflow data, and wherein the first operation request is used for the service system to determine whether the first operation is allowed to be executed based on the first verification information by:
determining that the first operation is allowed to be executed in response to determining that the duration indicated by the attachment identification information is less than a preset duration.

15. The electronic device of claim 12, wherein the first verification information comprises the identity identification information and the attachment identification information corresponding to the first workflow data, and wherein the first operation request is used for the service system to determine whether the first operation is allowed to be executed based on the first verification information by:
determining that the first operation is allowed to be executed in response to determining that a predefined account comprises a user account indicated by the identity identification information, and that the duration indicated by the attachment identification information is less than a preset duration.

16. The electronic device of claim 11, wherein the viewing request comprises identity identification information, the identity identification information corresponds to a viewing level, and different viewing levels correspond to different first workflow data; and wherein the identity identification information is used for the service system to obtain the first workflow data corresponding to the viewing level.

17. The electronic device of claim 16, wherein the viewing level corresponds to a rank of a user account indicated by the identity identification information.

18. The electronic device of claim 16, wherein the one or more processors are further caused to perform actions comprising:
in response to detecting that a first user account sends the first workflow data to a second user account, determining whether a rank of the first user account is greater than a rank of the second user account;
in accordance with a determination that the rank of the first user account is greater than the rank of the second user account, displaying at least one type of permission configuration information, wherein the permission configuration information is used to indicate viewing permission; and
determining a viewing level of the second user account based on selected permission configuration information.

19. The electronic device of claim 11, wherein the first operation comprises at least one of the following: sharing the first workflow data to a designated platform, commenting on the first workflow data, or accessing or saving an attachment in the first workflow.

20. A computer-readable medium, storing a computer program thereon, wherein the program, when executed by a processor, implements operations comprising:
sending a first workflow viewing request to a service system, wherein the service system is configured to return first workflow data and first verification information based on an identity of a sender satisfying a permission requirement;
displaying the first workflow data returned from the service system;
sending, to the service system, a first operation request in response to detecting a first operation on the displayed first workflow data, wherein the first operation request comprises the first verification information, and the first operation request is used for the service system to determine whether the first operation is allowed to be executed based on the first verification information; and
displaying an execution result of the first operation in response to the first operation being allowed to be executed.
